(19) United States
(12) Patent Application Publication
(10) Pub. No.: US 2014/0251348 A1
(43) Pub. Date: Sep. 11, 2014

(54) Method for Making and Using a Comfort Guard for Orthodontic Treatments

(71) Applicants: Marc Lemchen, New York, NY (US); Jennifer Salzer, New York, NY (US)

(72) Inventors: Marc Lemchen, New York, NY (US); Jennifer Salzer, New York, NY (US)

(21) Appl. No.: 14/198,530

(22) Filed: Mar. 5, 2014

Related U.S. Application Data
(60) Provisional application No. 61/772,910, filed on Mar. 5, 2013.

(51) Int. Cl. A61C 7/12; A61C 7/14

(52) U.S. Cl. CPC A61C 7/125; A61C 7/146
USPC 128/861; 433/24

(57) ABSTRACT

A comforting mouth guard is disclosed for use after indirect bonding of orthodontic brackets onto teeth of a patient and installation of orthodontic wires between the brackets. The mouth guard includes an indirect bonding tray having a wall of soft material and molded-in channels defined in the soft material of the wall so that the tray is reinsertable over the orthodontic wires and brackets after bonding to the teeth of the patient to provide a conformal fit to the teeth, brackets and wires and to lock in place over the brackets and wires.

### RELATED APPLICATIONS

The present application is related to U.S. Provisional Patent Application, Ser. No. 61/772,910, filed on Mar. 5, 2013, which is incorporated herein by reference and to which priority is claimed pursuant to 35 USC 119.

### BACKGROUND

1. Field of the Technology

The disclosure relates to the field of orthodontic methods and in particular to mouth guards for providing comfort after fitting with orthodontic braces using an indirect transfer tray.

2. Description of the Prior Art

Traditionally orthodontic brackets or “braces” were applied to the teeth one at time. Indirect bonding is a technique that allows for all of the braces to be placed into the patient's mouth at the same time. “Indirect” describes the process of the braces being initially applied one by one to a plaster model of the patient's teeth rather than directly to the teeth. The braces are then transferred to the patient's mouth as a complete or integral set of braces. The process of fitting a patient with orthodontic braces is dramatically shorter when applied with an indirect bonding process. Because all of the measurements and positioning of the braces are done on a plaster model of the teeth rather than in the patient's mouth, the indirect bonding process is much more comfortable and precise than live or in-chair fitting methods.

### BRIEF SUMMARY

The illustrated embodiments of the invention are directed to a comforting mouth guard for use after indirect bonding of orthodontic brackets onto teeth of a patient and installation of orthodontic wires between the brackets. The mouth guard includes an indirect bonding tray having a wall of soft material and molded-in channels defined in the soft material of the wall so that the tray is reinsertable over the orthodontic wires and brackets after bonding to the teeth of the patient to provide a conformal fit to the teeth, brackets and wires and to lock in place over the brackets and wires.

The tray includes a custom-made mouth guard for the patient, allowing the patient to accommodate to the braces more comfortably.

The bonding tray in one embodiment includes a hard plastic tray conforming to the teeth and brackets indirectly placed thereon, and a soft, compliant cushioning layer disposed or formed inside the hard plastic tray in which the molded-in channels are defined to allow accommodation of the orthodontic wires extending between the brackets. The tray can then be inserted over the teeth, brackets and the wires, which wires fit into the molded-in channels in the wall of the tray to provide a comfortable and conforming fit to the patient's teeth with the brackets and wires installed.

A temporary cushioning layer or a bed of deformable plastic fiber is disposed in the tray so that when the tray is orally reinserted into the patient, the orthodontic wire does not interfere with the seating of the mouth guard due to the deformation of the temporary cushioning layer or bed of deformable plastic fiber.

The fiber bed is permanently compliant so that the fiber bed need not be replaced after an alteration in the orthodontic wires.

The scope of the invention also includes as an embodiment a method of making a comforting mouth guard for use after indirect bonding of orthodontic brackets onto teeth of a patient and installation of orthodontic wires between the brackets. The method includes the steps of: establishing relative placement of a plurality of orthodontic brackets on a model of a patient's teeth; disposing spacers between the plurality of orthodontic brackets on the model to define corresponding channels in a wall of a transfer tray for accommodation of orthodontic wires to be installed between the orthodontic brackets; making an impression in a soft molding material included in the transfer tray by inserting the transfer tray including the soft molding material into the model with the brackets and spacers in position; removing the transfer tray carrying the soft molding material from the model taking with the transfer tray the brackets and spacers embedded into the soft molding material; removing the spacers from the transfer tray leaving the brackets embedded therein; preparing the brackets in the transfer tray for fixation to the teeth of the patient; inserting the transfer tray with embedded brackets into a patient's mouth and fixating the brackets to the patient's teeth; removing the transfer tray with the soft molding material therein from the patient's teeth and mouth; installing orthodontic wires between the plurality of brackets fixed on the patient's teeth; and reinserting the transfer tray with the soft molding material therein and with the molded-in channels therein to fit the orthodontic wires into the molded-in channels thereby providing a comforting mouth guard.

In another embodiment the tray is composed of a shell of rigid material and where the soft molding material comprises a soft, compliant cushioning layer carried by the transfer tray so that making the impression in the soft molding material included in the transfer tray comprises inserting the brackets and spacers into the cushioning layer.

In still another embodiment a bed of deformable plastic fiber is disposed into the tray onto the soft molding material after the channels are defined therein.

The invention can also be characterized as a method of making a comforting mouth guard for use after indirect bonding of orthodontic brackets onto teeth of a patient and installation of orthodontic wires between the brackets including the steps of: modifying the manufacture of an indirect transfer tray from a model of a patient's teeth; which indirect transfer tray also serves as a body of a mouth guard, by disposing spacers between the plurality of orthodontic brackets on the model to define corresponding channels in the mouth guard for accommodation of orthodontic wires to be installed between the orthodontic brackets; fixing the brackets to the teeth; removing the spacers from the mouth guard either before or after fixing the brackets to the teeth; and removing the body of the mouth guard from the brackets fixed to the teeth, so that the defined channels in the mouth guard readily accommodate orthodontic wires to be installed between the brackets to provide a comforting and conforming mouth guard for later reinsertion into the mouth of the patient.

The method further includes the step of disposing a bed of deformable plastic fiber into the mouth guard after the channels are defined therein.

The spirit and scope of the invention contemplates an embodiment directed to a comforting mouth guard for use after indirect bonding of orthodontic brackets onto teeth of a patient and installation of orthodontic wires between the brackets including a modified indirect transfer tray capable of carrying a plurality of orthodontic brackets and spacers between the brackets for use with a model of a patient's teeth, which modified indirect transfer tray serves as a body of a mouth guard, molded-in channels defined in the mouth guard by the spacers during the molding of the mouth guard, the molded-in channels extending between adjacent ones of the plurality of orthodontic brackets for accommodation of orthodontic wires installed between adjacent ones of the plurality of orthodontic brackets fixed to the teeth of the patient, wherein the spacers are removed from the body of the mouth guard, so that the defined channels in the mouth guard are open and available to readily accommodate the orthodontic wires.

The comforting mouth guard further includes a bed of deformable plastic fiber disposed in the mouth guard for repeated compliant engagement with the plurality of brackets and orthodontic wires.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a depiction of the prior art step of fixing orthodontic brackets to a model of a patient's teeth.

FIG. 2 is a depiction of the prior art step of making an impression of the orthodontic brackets in FIG. 1 in an indirect transfer tray.

FIG. 3 is a depiction of the prior art step of removing the orthodontic brackets from the model using the indirect transfer tray.

FIG. 4 is a depiction of the prior art step of applying a light curable adhesive to the orthodontic brackets in the indirect transfer tray.

FIG. 5 is a depiction of the prior art step of inserting the orthodontic brackets in the indirect transfer tray into the mouth of a patient for fixing the brackets to the teeth, after which the tray is removed leaving the brackets in place on the teeth. The orthodontic wires are then installed between the brackets completing placement of the braces.

FIG. 6 is a depiction of the invention wherein spacers are disposed between the orthodontic brackets on the model in the dental laboratory prior to incorporation of the spacers and brackets into the modified indirect transfer tray.

FIG. 7 is a depiction of the invention wherein the modified indirect transfer tray is removed from the teeth after fixation of the brackets to the patient's teeth and the spacers have been removed showing the molded-in channels which will accommodate the orthodontic wires, when the modified transfer tray is reinserted into the mouth and used as a comforting and compliant mouth guard.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

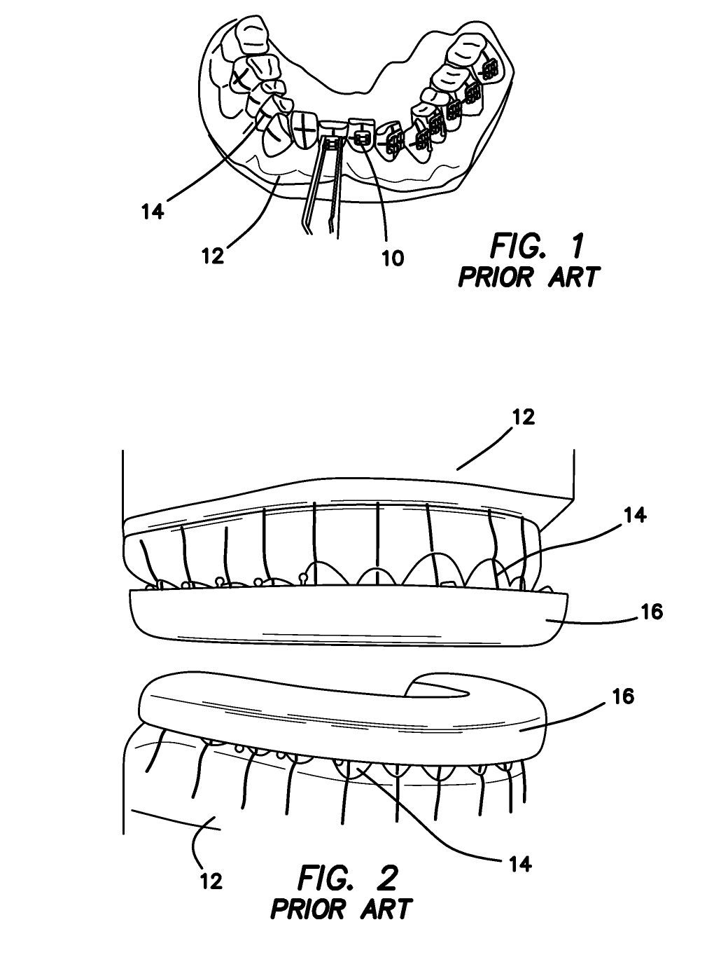

In the practice of installing a set of orthodontic brackets 10 using the conventional indirect bonding method, a cast, three dimensional model 12 of the patient's teeth is first made as taken by an impression from the patient's teeth. The orthodontic brackets 10 are individually and temporarily placed or glued on the teeth 14 of the model 12 in the desired positions and orientations as shown in FIG. 1.

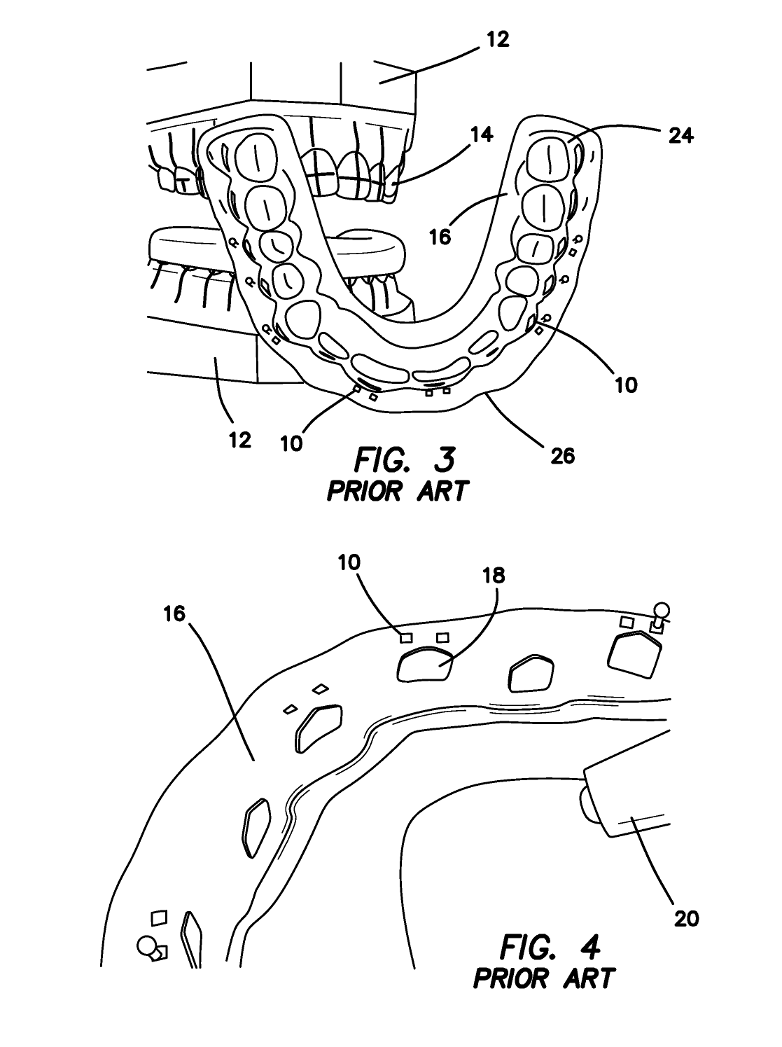

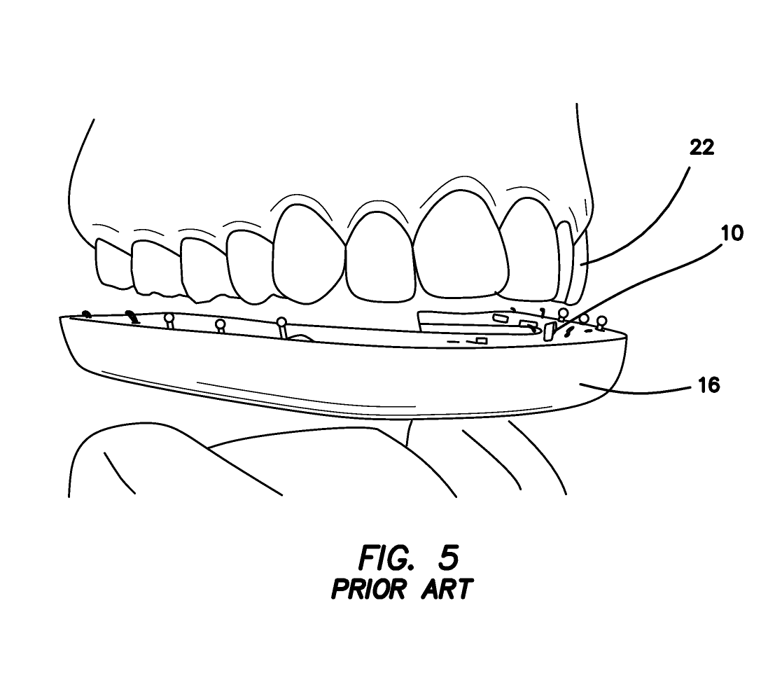

Once the brackets 10 are glued to the teeth 14 of the model 12, a soft, transparent plastic tray 16, resembling an athletic mouth guard, is pressed against the teeth 14 of the model 12 and bonded to the brackets 10 as shown in FIG. 2 using an adhesive glue or bonding gel inside tray 16. The plastic tray 16 with the embedded brackets 10 in it is then pulled off the model 12 as shown in FIG. 3. The relative strengths of the bonds of brackets 10 to teeth 14 of model 12 is chosen so that it is weaker than the strength of the bond of the gel or adhesive loaded into tray 16 with the brackets 10. Tray 16 is generally referred to as a “transfer tray”. Hence when the semiflexible or flexible tray 16 is peeled off the teeth 14 of model 12, the brackets 10 reliably and consistent hold to the tray 16 and maintain their relative placement with respect to each other without alteration. The teeth 22 of the patient are cleaned and prepared for bonding to the brackets 10 by conventional methods and means. Light curable bonding adhesive is applied to the bonding surfaces 18 of the brackets 10 in embedded in the tray 16 as shown in FIG. 4 using a conventional applicator 20. The tray 16 is then brought into contact with the patient's teeth 22 by inserting the tray 16 as a fitted mouthpiece as diagrammatically shown in FIG. 5.

Light is then shined through the tray 16 onto each of the brackets 10 in the tray 16. The light curable adhesive cures to the tooth 22 under the action of the light and the tray 16 is then pulled away from the patient's mouth and teeth 22 leaving the brackets 10 in place on the teeth 22 in the intended relative positions of the teeth 22. Orthodontic wires (not shown) are then applied to the brackets in a conventional manner to effectuate the orthodontic treatment intended. Days of discomfort follow as the patient adjusts to the feel of the protruding brackets 10 and wires in his or her mouth. To alleviate this discomfort in children or others when needed, wax is applied over the brackets 10 and wires to provide a smoother and more comfortable surface until the inner surfaces of the mouth and cheeks can adjust to the orthodonture.

According to the illustrated embodiment of the invention, the size and design of tray 16 is modified to use a modified tray 16a in the procedures of FIGS. 1-5, so that after the installation of the brackets 10 onto teeth 22, removal of the tray 16a, and the installation of the orthodontic wires, the tray 16a has enough additional clearance from brackets 10, it can be reinserted in the patient's mouth over the wires which are conventionally placed after bonding. The tray 16a would also be able to be reinserted in the mouth as a comfort or mouth guard, even if wires were in place in the original transfer tray 16 of FIGS. 1-5, which is not a currently practiced technique. The tray 16a acts as a custom-made mouth guard, allowing the patient to accommodate to the braces (brackets 10 and wires) more comfortably.

Some of the prior art trays 16 have a softer material 24 holding the brackets 10 and a harder outer plastic shell 26 (FIG. 3) forming the outer surface of tray 16 to aid in seating the brackets 10. The softer layer 24 is molded to match the shape of the brackets 10 and the teeth 22 against which it is to be placed. The trays 16 could also be made of a soft material 24, as a single integral tray, without the harder outer tray shell 26. There are no wires in place on the brackets 10 nor any provision made in the softer layer 24 to accommodate the wires, since they are fixed to the brackets only after the tray 16 is removed.

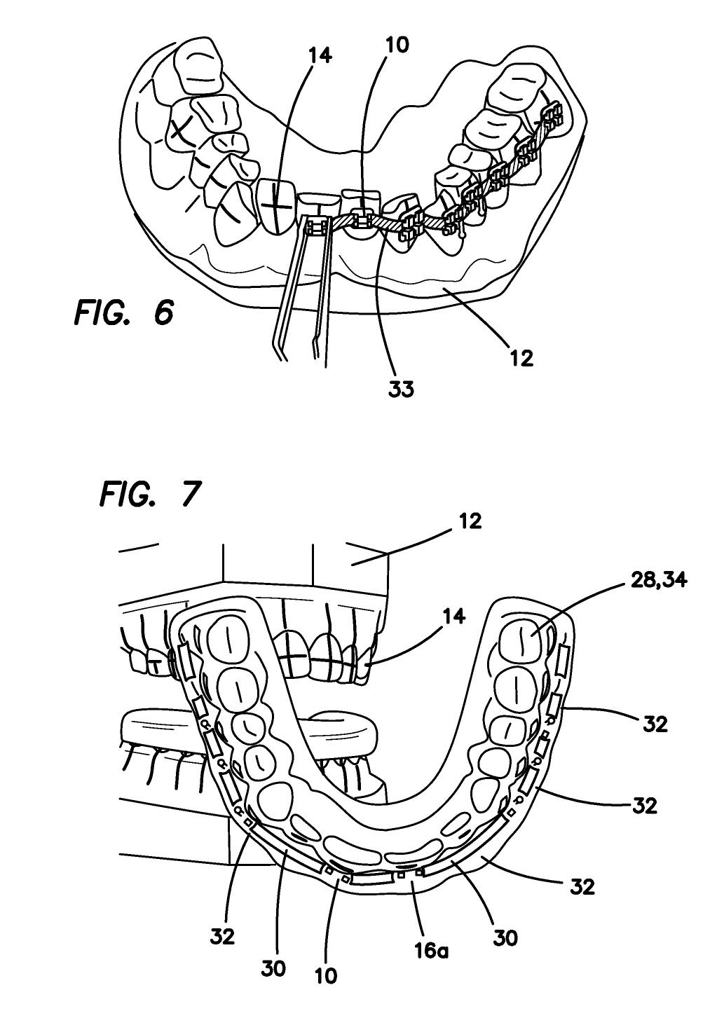

In the illustrated embodiment of the invention the softer inner layer 24 in the hard plastic tray 26 is replaced with a soft material 28 capable of locking in the brackets 10 for transfer from the laboratory model 12 to the patient's mouth, but durable enough to be reinserted into the mouth after bonding of the brackets 10 to teeth 22. Soft material 28 may in fact be the same as soft material 24 currently used or any other soft oral polymer used in mouth guards or mouth pieces. During the laboratory phase of the process, wire or spacers 33 is disposed from bracket 10 to bracket 10 to leave a channel or trough 30 defined in material 28 for the installed orthodontic wire to be placed post bonding as shown in FIG. 6. Once the tray 16a is peeled from the model 12 in FIG. 7, spacers 33 are removed from tray 16a leaving the defined channels 30 into which the orthodontic wires will later be disposed. This allows the transfer tray 16a to be refitted into the mouth following the placement appointment or braces fitting.

A cushioning layer 32 is formed in material 28 makes between channel 30 where the wire will be accommodated between the brackets 10 and between the inner surface of the mouth and lips. The tray 16a is formed as in the prior art, but the area where the orthodontic wires are to be positioned between adjacent brackets 10 is blocked out in the tray 16a by spacers 33, leaving open channels 30 in the walls of completed tray 16a. After the fixation of brackets 10 to teeth 22 and the installation of the wires following the step of FIG. 5, the tray 16a is then reinserted into the mouth over the teeth 22, brackets 10 and the wires. The brackets 10 and wires will fit or be accommodated into the blocked-out channels 30 and molded indentations for the brackets 10 in the all of tray 16a to provide a comfortable and conforming fit to the patient's teeth with the brackets 10 and installed wires.

In another embodiment a temporary cushioning layer or a bed 34 of deformable plastic fiber is disposed in the tray in place of the softer material 28 described above in FIG. 7. When the tray is placed back into the mouth of the patient, the wire will not interfere with the seating of this temporary “comfort guard” due to the easy deformation of the fiber bed 34. The fiber bed 34 need not be replaced even after alterations in the wires following the initial bonding. The fiber bed 34 still leaves enough of the tray material 28 around each bracket 10 to lock them in for transfer, but is deformable in the area where the wire transits from bracket 10 to adjacent bracket 10 in the mouth.

Channels 30 or other types of molded-in voids may be provided in any part of the tray 16a to accommodate alterations made in patient post bonding for comfort or mouth protection making it an immediate mouth guard. The tray 16a only functions in the way disclosed above until tooth movement resulted in tray 16a no longer fitting and or tray 16a impeded intended tooth movement. At that time a new, appropriately modified tray 16a would be manufactured. The key is the creation of a mouth or comfort tray 16a directly from the transfer tray. Such a tray 16a could be manufactured by taking an impression or dental scan and using the model 12 to make the tray 16a, or just use a soft material 28, and flow it over the appliance in the mouth, keeping it isolated from other surfaces or structures while it sets.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claim. For example, notwithstanding the fact that the elements of a claim are set forth below in a certain combination, it must be expressly understood that the embodiments includes other combinations of fewer, more or different elements, which are disclosed in above even when not initially claimed in such combinations. A thing that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A comforting mouth guard for use after indirect bonding of orthodontic brackets onto teeth of a patient and installation of orthodontic wires between the brackets comprising:
an indirect bonding tray having a wall of soft material; and
molded-in channels defined in the soft material of the wall so that the tray is reinsertable over the orthodontic wires and brackets after bonding to the teeth of the patient to provide a conformal fit to the teeth, brackets and wires and to lock in place over the brackets and wires.

2. The mouth guard of claim 1 where the tray comprises a custom-made mouth guard for the patient, allowing the patient to accommodate to the braces more comfortably.

3. The mouth guard of claim 1 where the bonding tray comprises:
a hard plastic tray conforming to the teeth and brackets indirectly placed thereon; and
a soft, compliant cushioning layer formed inside the hard plastic tray in which the molded-in channels are defined to allow accommodation of the orthodontic wires extending between the brackets so that the tray can then be inserted over the teeth, brackets and the wires, which wires fit into the molded-in channels in the wall of the tray to provide a comfortable and conforming fit to the patient's teeth with the brackets and wires installed.

4. The mouth guard of claim 1 where a temporary cushioning layer or a bed of deformable plastic fiber is disposed in the tray so that when the tray is orally reinserted into the patient, the orthodontic wire does not interfere with the seating of the mouth guard due to the deformation of the temporary cushioning layer or bed of deformable plastic fiber.

5. The mouth guard of claim 4 where the fiber bed is permanently compliant so that the fiber bed need not be replaced after an alteration in the orthodontic wires.

6. A method of making a comforting mouth guard for use after indirect bonding of orthodontic brackets onto teeth of a patient and installation of orthodontic wires between the brackets comprising:
establishing relative placement of a plurality of orthodontic brackets on a model of a patient's teeth;
disposing spacers between the plurality of orthodontic brackets on the model to define corresponding channels in a wall of a transfer tray for accommodation of orthodontic wires to be installed between the orthodontic brackets;
making an impression in a soft molding material included in the transfer tray by inserting the transfer tray including the soft molding material into the model with the brackets and spacers in position;
removing the transfer tray carrying the soft molding material from the model taking with the transfer tray the brackets and spacers embedded into the soft molding material;
removing the spacers from the transfer tray leaving the brackets embedded therein;
preparing the brackets in the transfer tray for fixation to the teeth of the patient;
inserting the transfer tray with embedded brackets into a patient's mouth and fixating the brackets to the patient's teeth;
removing the transfer tray with the soft molding material therein from the patient's teeth and mouth;
installing orthodontic wires between the plurality of brackets fixed on the patient's teeth; and
reinserting the transfer tray with the soft molding material therein and with the molded-in channels therein to fit the orthodontic wires into the molded-in channels thereby providing a comforting mouth guard.

7. The method of claim 6 where the tray is composed of a shell of rigid material and where the soft molding material comprises a soft, compliant cushioning layer carried by the transfer tray so that making the impression in the soft molding material included in the transfer tray comprises inserting the brackets and spacers into the cushioning layer.

8. The method of claim 6 further comprising disposing a bed of deformable plastic fiber into the tray onto the soft molding material after the channels are defined therein.

9. A method of making a comforting mouth guard for use after indirect bonding of orthodontic brackets onto teeth of a patient and installation of orthodontic wires between the brackets comprising:
modifying the manufacture of an indirect transfer tray from a model of a patient's teeth, which indirect transfer tray also serves as a body of a mouth guard, by disposing spacers between the plurality of orthodontic brackets on the model to define corresponding channels in the mouth guard for accommodation of orthodontic wires to be installed between the orthodontic brackets;
fixing the brackets to the teeth;
removing the spacers from the mouth guard either before or after fixing the brackets to the teeth; and
removing the body of the mouth guard from the brackets fixed to the teeth, so that the defined channels in the mouth guard readily accommodate orthodontic wires to be installed between the brackets to provide a comforting and conforming mouth guard for later reinsertion into the mouth of the patient.

10. The method of claim 9 further comprising disposing a bed of deformable plastic fiber into the mouth guard after the channels are defined therein.

11. A comforting mouth guard for use after indirect bonding of orthodontic brackets onto teeth of a patient and installation of orthodontic wires between the brackets comprising:
a modified indirect transfer tray capable of carrying a plurality of orthodontic brackets and spacers between the brackets for use with a model of a patient's teeth, which modified indirect transfer tray serves as a body of a mouth guard,
molded-in channels defined in the mouth guard by the spacers during the molding of the mouth guard, the molded-in channels extending between adjacent ones of the plurality of orthodontic brackets for accommodation of orthodontic wires installed between adjacent ones of the plurality of orthodontic brackets fixed to the teeth of the patient; and
wherein the spacers are removed from the body of the mouth guard, so that the defined channels in the mouth guard are open and available to readily accommodate the orthodontic wires.

12. The comforting mouth guard of claim 11 further comprising a bed of deformable plastic fiber disposed in the mouth guard for repeated compliant engagement with the plurality of brackets and orthodontic wires.
